(19) United States
(12) Patent Application Publication
(10) Pub. No.: US 2012/0288387 A1
(43) Pub. Date: Nov. 15, 2012

(54) RECIPROCATING PUMP WITH INTERSECTING BORE GEOMETRY

(75) Inventors: Wesley D. Freed, Fort Worth, TX (US); Mark C. Dille, Fort Worth, TX (US); Scott Skurdalsvold, Mansfield, TX (US)

(73) Assignee: S.P.M. FLOW CONTROL, INC., Fort Worth, TX (US)

(21) Appl. No.: 13/451,842

(22) Filed: Apr. 20, 2012

Related U.S. Application Data
(60) Provisional application No. 61/477,471, filed on Apr. 20, 2011.

(51) Int. Cl. F04B 53/00; B23P 15/00

(52) U.S. Cl. 417/454; 29/888.02

(57) ABSTRACT

A reciprocating pump housing having a suction valve bore, a discharge valve bore, a plunger bore and an access bore. The suction and discharge bores are disposed on a first centerline and the plunger and access bores are disposed along a second centerline perpendicular to the first centerline. The pump housing includes a first annular transition zone extending between an intersection of the plunger bore and suction bore and an intersection of the access bore and the discharge valve bore. The housing also includes a second annular transition zone extending between an intersection of the suction valve bore and access bore and an intersection of the plunger bore and discharge valve bore. The first and second transition zones intersect along a third centerline perpendicular to the intersection of first and second centerlines, each including a curvature along their lengths to blend the intersections between the bores and reduce tensile stresses.

### CROSS-REFERENCE TO RELATED APPLICATIONS

This application claims priority to U.S. Provisional Patent Application Ser. No. 61/477,471, filed on Apr. 20, 2011, which is incorporated herein by reference in its entirety.

### TECHNICAL FIELD

This disclosure relates in general to reciprocating pumps, more particularly to the pump fluid housing thereof, and even more particularly to the design of the pump fluid housing to reduce fatigue failure thereof.

### BACKGROUND OF THE DISCLOSURE

Large pumps are commonly used for mining and oilfield applications, such as, for example, hydraulic fracturing. During hydraulic fracturing, fracturing fluid (i.e., cement, mud, frac sand and other material) is pumped at high pressures into a wellbore to cause the producing formation to fracture. One commonly used pump in hydraulic fracturing is a high pressure reciprocating pump, like the SPM® Destiny™ TWS 2500 frac pump, manufactured by S.P.M. Flow Control, Inc. of Fort Worth, Tex. In operation, the fracturing fluid is caused to flow into and out of a pump housing having a fluid chamber as a consequence of the reciprocation of a piston-like plunger respectively moving away from and toward the fluid chamber. As the plunger moves away from the fluid chamber, the pressure inside the chamber decreases, creating a differential pressure across an inlet valve, drawing the fracturing fluid through the inlet valve into the chamber. When the plunger changes direction and begins to move towards the fluid chamber, the pressure inside the chamber substantially increases until the differential pressure across an outlet valve causes the outlet valve to open, enabling the highly pressurized fracturing fluid to discharge through the outlet valve into the wellbore.

One common problem associated with operating reciprocating pumps at alternating high and low pressures is fatigue failure in the pump housing near the fluid chamber. For example, the pump housing or fluid end of such reciprocating pumps typically include a suction valve bore for receiving the pumping fluid, a discharge valve bore for discharging the pumping fluid at a high pressure, a plunger bore for receiving the reciprocating plunger, and an access bore providing access to the plunger bore, all of which typically intersect in the vicinity of a fluid chamber. Unfortunately, stress concentrations arise at these intersections during high pressure pumping operations. Specifically, the alternating high and low pressures resulting from each stroke of a plunger cycle act upon the walls of the bores resulting in high stress concentrations and leading to fatigue failure close to or at these intersections. Thus, there is a need for a reciprocating pump housing in which fatigue failures can be reduced at the areas of the pump housing defined by the respective intersections of the suction valve bore, the discharge valve bore, the plunger bore and the access bore.

### SUMMARY

In a first aspect, there is provided a reciprocating pump housing including a suction valve bore and a discharge valve bore disposed along a first centerline and a plunger bore and an access bore disposed along a second centerline. The second centerline is substantially perpendicular to the first centerline. The pump housing also includes a first annular transition zone extending between an intersection of the plunger bore and suction valve bore and an intersection of the access bore and discharge valve bore. The first annular transition zone includes a curvature along its length to blend the intersections between the suction valve bore, the discharge valve bore, the plunger bore and the access bore. The pump housing also includes a second annular transition zone extending between an intersection of the suction valve bore and access bore and an intersection of the plunger bore and discharge valve bore, the second annular transition zone having a curvature along its length to blend the intersections between the suction valve bore, the discharge valve bore, the plunger bore and the access bore. According to some embodiments, the first and second annular transition zones intersect along a third centerline generally perpendicular to and extending through an intersection of the first and second centerlines. This particular configuration substantially reduces tensile stresses at the first and second annular transition zones.

In certain embodiments, the first annular transition zone curvature has a radius between the third centerline and the discharge valve bore of between about 10% and about 24% of the diameter of the discharge valve bore at the intersection of the plunger bore.

In other certain embodiments, the first annular transition zone curvature has a radius between the third centerline and the discharge valve bore of between about 12% and about 20% of the diameter of the discharge valve bore at the intersection of the plunger bore.

In yet another embodiments, the first annular transition zone curvature has a radius between the third centerline and the discharge valve bore of between about 10% and about 16% of the diameter of the discharge valve bore at the intersection of the plunger bore.

In still yet another embodiment, the first annular transition zone curvature has a radius between the third centerline and the suction valve bore of between about 5% and about 20% of the diameter of the discharge valve bore at the intersection of the plunger bore and the discharge bore.

In other certain embodiments, the first annular transition zone curvature has a radius between the third centerline and the suction valve bore of between about 5% and about 15% of the diameter of the discharge valve bore at the intersection of the plunger bore and the discharge bore.

In still another embodiment, the first annular transition zone curvature has a radius between the third centerline and the suction valve bore of between about 8% and about 12% of the diameter of the discharge valve bore at the intersection of the plunger bore and the discharge bore.

In yet another embodiment, the second annular transition zone curvature has a radius between the third centerline and the discharge valve bore of between about 10% and about 24% of the diameter of the discharge valve bore at the intersection of the plunger bore.

In still yet another embodiment, the second annular transition zone curvature has a radius between the third centerline and the discharge valve bore of between about 12% and about 20% of the diameter of the discharge valve bore at the intersection of the plunger bore.

In yet another embodiment, the second annular transition zone curvature has a radius between the third centerline and the discharge valve bore of between about 10% and about 16% of the diameter of the discharge valve bore at the intersection of the plunger bore.

In other certain embodiments, the second annular transition zone curvature has a radius between the third centerline and the suction valve bore of between about 5% and about 20% of the diameter of the discharge valve bore at the intersection of the plunger bore and the discharge bore.

In yet another embodiment, the second annular transition zone curvature has a radius between the third centerline and the suction valve bore of between about 5% and about 15% of the diameter of the discharge valve bore at the intersection of the plunger bore and the discharge bore.

In still another embodiment, the second annular transition zone curvature has a radius between the third centerline and the suction valve bore of between about 8% and about 12% of the diameter of the discharge valve bore at the intersection of the plunger bore and the discharge bore.

In other certain embodiments, the diameter of the suction valve bore at the intersection with the plunger bore is larger than the diameter of the discharge valve bore at the intersection with the plunger bore.

In yet another embodiment, the diameter of the suction valve bore at the intersection with the plunger bore is different from the diameter of the discharge valve bore at the intersection with the plunger bore.

In still another embodiment, the discharge valve bore diameter comprises a diameter different from a diameter of the plunger bore diameter.

In still yet another embodiment, the curvature of the first annular transition zone includes a first apex and the curvature of the second annular transition zone includes a second apex. The first apex at the intersection of the plunger bore and the suction valve bore is vertically spaced apart from the second apex a distance such that a tangent line extending through the first apex at a forty-five degree angle relative to the first centerline and a tangent line extending through the second apex at a forty-five degree angle relative to the first centerline intersect at a single point on the first centerline a distance of about two time the radius of the discharge valve bore at the intersection of the discharge valve bore and the plunger bore.

In a second aspect, there is provided a reciprocating pump housing including a suction valve bore having an inlet valve therein to control fluid flow through a suction manifold into a fluid chamber and a discharge valve bore having a discharge valve to control fluid through a discharge port from the fluid chamber. The housing further includes a plunger bore for receiving a plunger reciprocatingly movable into and out of the fluid chamber and an access bore for providing access to the plunger bore. Also included is a first annular transition zone extending between an intersection of the plunger bore and suction valve bore and an intersection of the access bore and discharge bore, the first annular transition zone having a curvature along its length and a second annular transition zone extending between an intersection of the suction bore and access bore and an intersection of the plunger bore and discharge bore, the first annular transition zone having a curvature along its length. In the disclosed embodiment, the situs of each of the intersections define curved surfaces thereby reducing the tensile stress at all of the intersections.

In certain embodiments, the first and second annular transition zones form a generally spherical fluid chamber.

In certain embodiments, the first and second annular transition zones intersect along a centerline generally perpendicular to an intersection of a suction valve bore centerline and a plunger bore centerline.

In certain embodiments, the first annular transition zone curvature has a radius between the third centerline and the discharge valve bore of between about 10% and about 24% of the diameter of the discharge valve bore at the intersection of the plunger bore.

In other certain embodiments, the first annular transition zone curvature has a radius between the third centerline and the discharge valve bore of between about 12% and about 20% of the diameter of the discharge valve bore at the intersection of the plunger bore.

In yet another embodiments, the first annular transition zone curvature has a radius between the third centerline and the discharge valve bore of between about 10% and about 16% of the diameter of the discharge valve bore at the intersection of the plunger bore.

In still yet another embodiment, the first annular transition zone curvature has a radius between the third centerline and the suction valve bore of between about 5% and about 20% of the diameter of the discharge valve bore at the intersection of the plunger bore and the discharge bore.

In other certain embodiments, the first annular transition zone curvature has a radius between the third centerline and the suction valve bore of between about 5% and about 15% of the diameter of the discharge valve bore at the intersection of the plunger bore and the discharge bore.

In still another embodiment, the first annular transition zone curvature has a radius between the third centerline and the suction valve bore of between about 8% and about 12% of the diameter of the discharge valve bore at the intersection of the plunger bore and the discharge bore.

In yet another embodiment, the second annular transition zone curvature has a radius between the third centerline and the discharge valve bore of between about 10% and about 24% of the diameter of the discharge valve bore at the intersection of the plunger bore.

In still yet another embodiment, the second annular transition zone curvature has a radius between the third centerline and the discharge valve bore of between about 12% and about 20% of the diameter of the discharge valve bore at the intersection of the plunger bore.

In yet another embodiment, the second annular transition zone curvature has a radius between the third centerline and the discharge valve bore of between about 10% and about 16% of the diameter of the discharge valve bore at the intersection of the plunger bore.

In other certain embodiments, the second annular transition zone curvature has a radius between the third centerline and the suction valve bore of between about 5% and about 20% of the diameter of the discharge valve bore at the intersection of the plunger bore and the discharge bore.

In yet another embodiment, the second annular transition zone curvature has a radius between the third centerline and the suction valve bore of between about 5% and about 15% of the diameter of the discharge valve bore at the intersection of the plunger bore and the discharge bore.

In still another embodiment, the second annular transition zone curvature has a radius between the third centerline and the suction valve bore of between about 8% and about 12% of the diameter of the discharge valve bore at the intersection of the plunger bore and the discharge bore.

In a third aspect, there is provided a method of manufacturing a reciprocating pump housing including forming a suction valve bore and a discharge valve bore along a first centerline and forming a plunger bore and an access bore along a second centerline that is substantially perpendicular to the first centerline. The method further includes forming a first annular transition zone extending between an intersection of the plunger bore and suction valve bore and an intersection of the access bore and discharge valve bore. The first annular transition zone is formed having a curvature along its length to blend the intersections between the suction bore, discharge bore, plunger bore, and access bore. The method also includes forming a second annular transition zone extending between an intersection of the suction valve bore and access bore and an intersection of the plunger bore and discharge valve bore. The second annular transition zone is formed having a curvature along its length to blend the intersections between the suction bore, discharge bore, plunger bore, and access bore. The first and second annular transition zones are also formed to intersect along a third centerline generally perpendicular to the intersection of first and second centerlines to reduce the tensile stresses in the pump housing.

In certain embodiments, the method further includes forming the first annular transition zone curvature having a radius between the third centerline and the discharge valve bore of between about 10% and about 24% of the diameter of the discharge valve bore at the intersection of the plunger bore.

In certain embodiments, the method further includes forming the first annular transition zone curvature having a radius between the third centerline and the discharge valve bore of between about 12% and about 20% of the diameter of the discharge valve bore at the intersection of the plunger bore.

In other certain embodiments, the method further includes forming the first annular transition zone curvature having a radius between the third centerline and the discharge valve bore of between about 10% and about 16% of the diameter of the discharge valve bore at the intersection of the plunger bore.

In yet another embodiment, the method further includes forming the first annular transition zone curvature having a radius between the third centerline and the suction valve bore of between about 5% and about 20% of the diameter of the discharge valve bore at the intersection of the plunger bore and the discharge bore.

In still another embodiment, the method further includes forming the first annular transition zone curvature having a radius between the third centerline and the suction valve bore of between about 5% and about 15% of the diameter of the discharge valve bore at the intersection of the plunger bore and the discharge bore.

In other certain embodiments, the method further includes forming the first annular transition zone curvature having a radius between the third centerline and the suction valve bore of between about 8% and about 12% of the diameter of the discharge valve bore at the intersection of the plunger bore and the discharge bore.

In still another embodiment, the method further includes forming the second annular transition zone curvature having a radius between the third centerline and the discharge valve bore of between about 10% and about 24% of the diameter of the discharge valve bore at the intersection of the plunger bore.

In yet another embodiment, the method further includes forming the second annular transition zone curvature having a radius between the third centerline and the discharge valve bore of between about 12% and about 20% of the diameter of the discharge valve bore at the intersection of the plunger bore.

In another embodiment, the method further includes forming the second annular transition zone curvature having a radius between the third centerline and the discharge valve bore of between about 10% and about 16% of the diameter of the discharge valve bore at the intersection of the plunger bore.

In still another embodiment, the method further includes forming the second annular transition zone curvature having a radius between the third centerline and the suction valve bore of between about 5% and about 20% of the diameter of the discharge valve bore at the intersection of the plunger bore and the discharge bore.

In another embodiment, the method further includes forming the second annular transition zone curvature having a radius between the third centerline and the suction valve bore of between about 5% and about 15% of the diameter of the discharge valve bore at the intersection of the plunger bore and the discharge bore.

In yet another embodiment, the method further includes further comprising forming the second annular transition zone curvature having a radius between the third centerline and the suction valve bore of between about 8% and about 12% of the diameter of the discharge valve bore at the intersection of the plunger bore and the discharge bore.

In a fourth aspect, there is provided a reciprocating pump housing including a suction valve bore and a discharge valve bore disposed along a first centerline and a plunger bore and an access bore disposed along a second centerline that is substantially perpendicular to the first centerline. The pump housing includes a first annular transition zone extending between an intersection of the plunger bore and suction valve bore and an intersection of the access bore and discharge valve bore. The first annular transition zone includes a curvature along its length to blend the intersections between the suction valve bore, the discharge valve bore, the plunger bore, and the access bore. The pump housing also includes second annular transition zone extending between an intersection of the suction valve bore and access bore and an intersection of the plunger bore and discharge valve bore, the second annular transition zone having a curvature along its length to blend the intersections between the suction valve bore, the discharge valve bore, the plunger bore and the access bore. In addition, the curvature of the first annular transition zone includes a first apex and the curvature of the second annular transition zone includes a second apex, wherein the first apex at the intersection of the plunger bore and the suction valve bore is vertically spaced apart from the second apex a distance such that a tangent line extending through the first apex at a forty-five degree angle relative to the first centerline and a tangent line extending through the second apex at a forty-five degree angle relative to the first centerline intersect at a single point on the first centerline a distance of about two time the radius of the discharge valve bore at the intersection of the discharge valve bore and the plunger bore.

In certain embodiments, the first and second annular transition zones intersect along a third centerline extending through and generally perpendicular to the intersection of first and second centerlines to thereby reduce tensile stresses at the first and second annular transition zones.

In other certain embodiments, the first annular transition zone curvature has a radius between the third centerline and the discharge valve bore of between about 10% and about 24% of the diameter of the discharge valve bore at the intersection of the plunger bore.

In yet another embodiment, the first annular transition zone curvature has a radius between the third centerline and the suction valve bore of between about 5% and about 20% of the diameter of the discharge valve bore at the intersection of the plunger bore and the discharge bore.

In still another embodiment, the second annular transition zone curvature has a radius between the third centerline and the discharge valve bore of between about 10% and about 24% of the diameter of the discharge valve bore at the intersection of the plunger bore.

In yet another embodiment, the second annular transition zone curvature has a radius between the third centerline and the suction valve bore of between about 5% and about 20% of the diameter of the discharge valve bore at the intersection of the plunger bore and the discharge bore.

In a fifth aspect, there is provided a method of manufacturing a reciprocating pump housing including forming a suction valve bore and a discharge valve bore along a first centerline and forming a plunger bore and an access bore along a second centerline, the second centerline substantially perpendicular to the first centerline. The method also includes forming a first annular transition zone extending between an intersection of the plunger bore and suction valve bore and an intersection of the access bore and discharge valve bore, the first annular transition zone formed having a curvature with an apex. The method further includes forming a second annular transition zone extending between an intersection of the suction valve bore and access bore and an intersection of the plunger bore and discharge valve bore, the first annular transition zone formed having a curvature with an apex. In addition, the method includes positioning the apex of the first annular transition zone apart from the apex of the second annular transition zone a distance such that a tangent line extending through the apex of the first annular transition zone at a forty-five degree angle relative to the first centerline and a tangent line extending through the apex of the second annular transition zone at a forty-five degree angle relative to the first centerline intersect at a single point on the first centerline at a distance of about twice the radius of the discharge valve bore at the intersection of the discharge valve bore and the plunger bore.

Other aspects, features, and advantages will become apparent from the following detailed description when taken in conjunction with the accompanying drawings, which are a part of this disclosure and which illustrate, by way of example, principles of the inventions hereof.

### DESCRIPTION OF THE FIGURES

The accompanying drawings facilitate an understanding of the various embodiments.

FIG. 1 is a sectional view, partially schematic, illustrating a reciprocating pump.

FIG. 2 is an enlarged sectional view of the pump housing of the reciprocating pump of FIG. 1.

FIG. 3 is a perspective sectional view of the pump housing of the reciprocating pump of FIG. 1.

### DETAILED DESCRIPTION

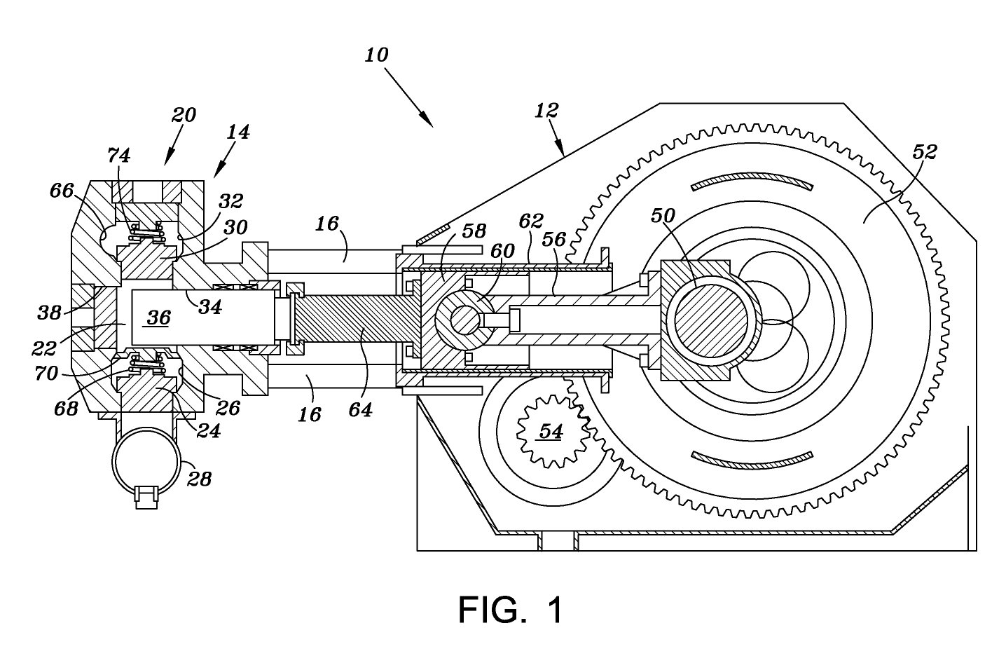

FIG. 1 is an illustration of a reciprocating pump assembly 10 having a crankshaft housing 12 operatively coupled to a fluid section 14 via the stay rods 16, the assembly 10 effective to pump fluid through a pump housing 20. The pump housing 20 includes one or more fluid chambers 22 (only one shown), which as explained in further detail below, are geometrically configured to minimize and and/or substantially eliminate fatigue failure that occurs in the general vicinity of the fluid chamber 22. In particular, the pump housing 20 typically includes a suction valve 24 in a suction bore 26 that draws fluid from within a suction manifold 28, a discharge valve 30 in a discharge bore 32 to control fluid output, a plunger bore 34 for housing a reciprocating plunger 36, and an access bore 38 to enable or otherwise facilitate access to the plunger bore 34. Such pump housings 20 are designed so that the suction valve bore 26, the discharge valve bore 32, the plunger bore 34 and the access bore 38 generally intersect in the vicinity of the fluid chamber 22. Accordingly, geometrical configurations disclosed herein are effective to reduce the stress concentrations at the respective bore intersections, and thus, the resulting fatigue failures that occur due to the alternating high and low pressures in the fluid chamber 22 during each stroke of a plunger cycle.

In the embodiment illustrated in FIG. 1, the pump assembly 10 is positionable to be free-standing on the ground, mounted to a trailer that can be towed between operational sites, and/or mounted, for example, to a skid for use in offshore operations. Referring specifically to the crankshaft housing 12, a crankshaft 50 is rotated by a bull gear 52, which is engaged with and driven by a pinion gear 54. A power source, such as an engine (not shown), connects to and rotates the pinion gear 54 during operation. A connecting rod 56 mechanically connects the crankshaft 50 to a cross head 58 via a wrist pin 60. The crosshead 58 is mounted within a stationary crosshead housing 62, which constrains the crosshead 58 to linear reciprocating movement. A pony rod 64 connects to the crosshead 58 and has its opposite end connected to the plunger 36 to enable reciprocating movement of the plunger 36, as discussed in further detail below. In some embodiments, the plunger 36 is optionally directly coupleable to the crosshead 58 to eliminate any need for the pony rod 64. In the embodiment illustrated in FIG. 1, the plunger 36 may be one of a plurality of plungers, such as, for example, three or five plungers, depending on the size of the pump assembly 10 (i.e., three cylinder, five cylinder, etc.).

As illustrated in FIG. 1, the plunger 36 extends through the plunger bore 34 so as to interface and otherwise extend within the fluid chamber 22. In operation, the valves 24 and 30 are actuated by a predetermined differential pressure inside the fluid chamber 22. The suction valve 24 actuates to control fluid flow through the suction manifold 28 into the fluid chamber 22, and the discharge valve 30 actuates to control fluid flow through a discharge port 66 from the fluid chamber 22. In particular, movement of the crankshaft 50 causes the plunger 36 to reciprocate or move longitudinally toward and away from, the fluid chamber 22. As the plunger 36 moves longitudinally away from the chamber 22, the pressure of the fluid inside the fluid chamber 22 decreases, which creates a differential pressure across the suction valve 24. In the embodiment illustrated in FIG. 1, a biasing member 68 (e.g., a spring) is located between the suction valve 24 and a valve stop 70. The biasing member 68 maintains a predetermined pressure on the suction valve 24 thereby maintaining the suction valve 24 in a closed position until the differential pressure across suction valve 24 is sufficient to overcome the force generated by the biasing member 68. The pressure differential within the chamber 22 enables actuation of the valve 24 to allow the fluid to enter the chamber 22 from the suction manifold 28. The pumped fluid is drawn within the fluid chamber 22 as the plunger 36 continues to move longitudinally away from fluid chamber 22 until the pressure difference between the fluid inside the chamber 22 and the fluid pressure inside the suction manifold 28 is small enough for the suction valve 24 to move to its closed position (via the biasing mechanism 68 and/or pressure within the chamber 22). As the plunger 36 changes directions and moves longitudinally toward the fluid chamber 22, the fluid pressure inside the chamber 22 gradually increases. Fluid pressure inside the chamber 22 continues to increase as the plunger 36 approaches the chamber 22 until the differential pressure across the discharge valve 30 is large enough to actuate the valve 30 (thereby compressing a biasing member 74). This enables pumping fluid to exit the chamber 22 via the discharge port 66.

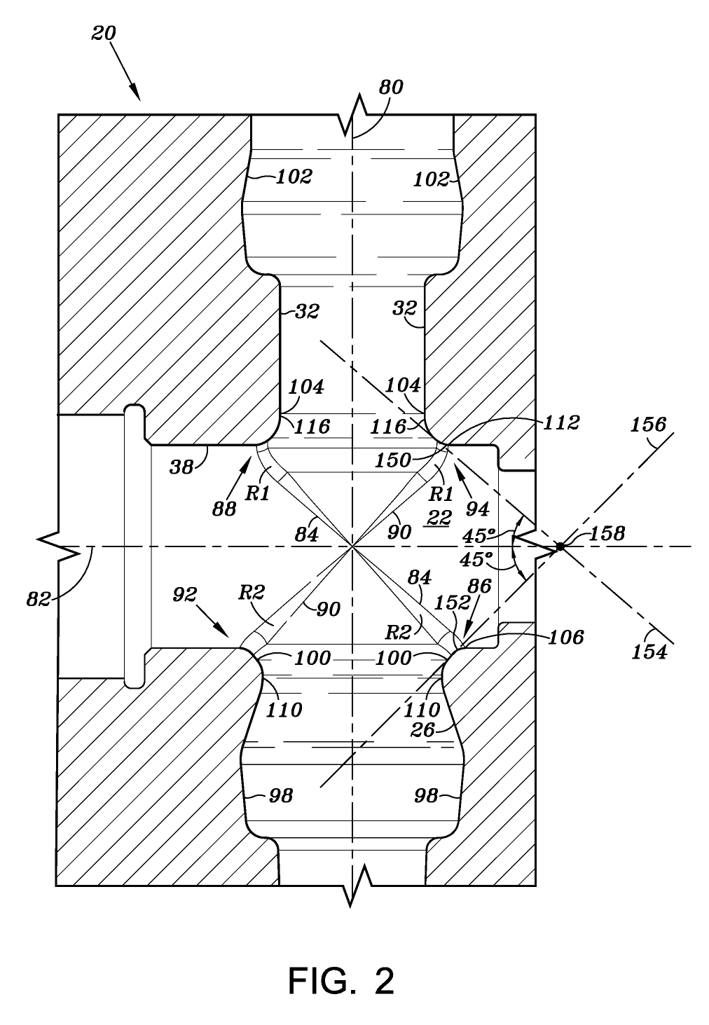

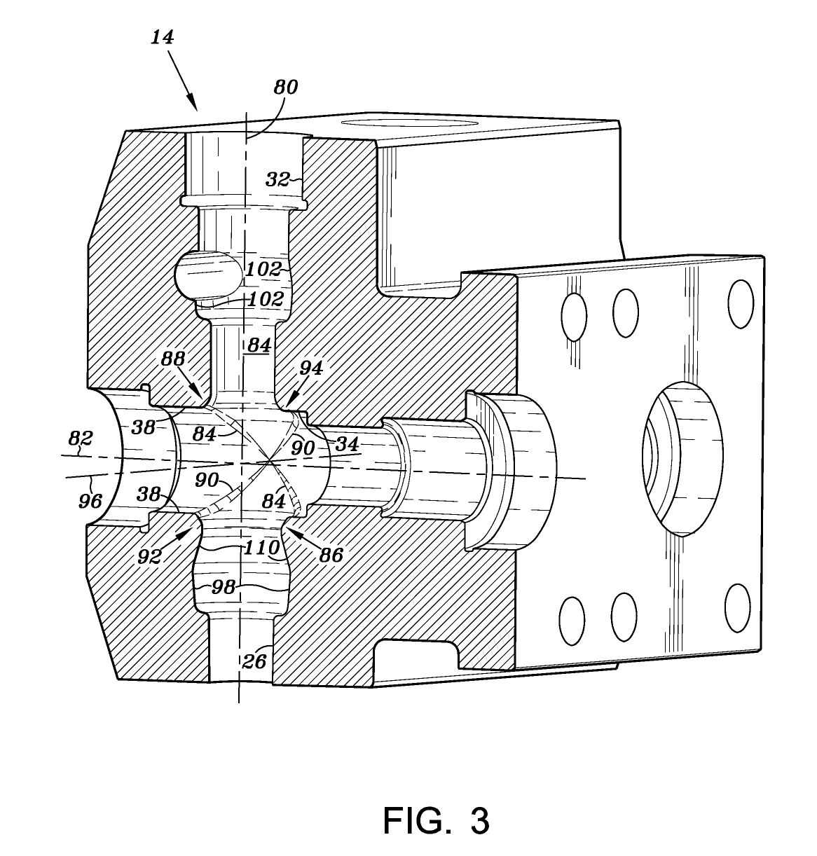

Referring now to FIGS. 2 and 3, the geometry of the fluid chamber 22, and in particular, the geometry of the respective intersections of the suction valve bore 26, the discharge valve bore 32, the plunger bore 34 and the access bore 38 are illustrated in a configuration to substantially reduce the tensile stresses and thus, fatigue failures that oftentimes occur at these intersections. Briefly, the pump housing 20 includes the suction valve bore 26 and the discharge valve bore 32 aligned along a centerline or axis 80 and the plunger bore 34 and access bore 38 aligned along a second centerline or axis 82. While FIGS. 2 and 3 are in section view and display only half of each of the bores 26, 32, 34 and 38, the other half of the bores are symmetrical and in mirror image thereto; thus, features described on one a side of centerline 80 or 82 are, unless otherwise noted, in mirror image on the other side of the respective centerline 80 or 82. As seen in the embodiment illustrated in FIGS. 2 and 3, the second centerline 82 is substantially perpendicular to the first centerline 80; however, the second centerline 82 is otherwise positionable at a different relative angle in other embodiments. A first annular transition zone 84 is formed to extend around fluid chamber 22 between an intersection 86 of the plunger bore 34 and the suction valve bore 26 and an intersection 88 of the access bore 38 and the discharge valve bore 32. As illustrated in FIGS. 2 and 3, the first annular transition zone 84 defines a generally circular or arcuate curvature along its length to blend the intersections 86 and 88 to thereby reduce tensile stresses on the walls of the fluid chamber 22. In addition to the first annular transition zone 84, the pump housing 20 also includes a second annular transition zone 90 extending around the fluid chamber between an intersection 92 of the suction valve bore 26 and the access bore 38 and an intersection 94 of the plunger bore 34 and the discharge valve bore 32. In the embodiment illustrated in FIGS. 2 and 3, the second annular transition zone 90 also defines a generally circular or arcuate curvature along its length to blend the intersections 92 and 94 to thereby reduce the tensile stresses on the fluid chamber 22. Referring to FIGS. 2 and 3, the first and second annular transition zones 84 and 90 intersect along a third centerline or axis 96 (FIG. 3) generally perpendicular to and extending through the intersection of the first and second centerlines 80 and 82.

Referring specifically to FIGS. 2 and 3, the curvature of the first annular transition zone 84 is preferably formed of a radius R1 between the third centerline 96 and the discharge valve bore 32 of between about 10% and about 24% of the diameter of the discharge valve bore 32 at the intersection 94. According to other embodiments, the curvature of the first annular transition zone 84 has a radius R1 between the third centerline 96 and the discharge valve bore 32 of about 12% and about 20% of the diameter of the discharge valve bore at the intersection 94. According to yet other embodiments, the radius R1 between the third centerline 96 and the discharge valve bore 32 is between about 10% and about 16% of the diameter of the discharge valve bore 32 at the intersection 94. Additionally, the curvature of the first annular transition zone 84 preferably has a radius R2 between the third centerline 96 and the suction valve bore 26 of between about 5% and about 20% of the diameter of the discharge valve bore 32 at the intersection 94. According to other certain embodiments, the curvature of the first annular transition zone 84 preferably has a radius R2 between the third centerline 96 and the suction valve bore 26 of between about 5% and about 15% of the diameter of the discharge valve bore 32 at the intersection 94. According to yet other embodiments, the radius R2 between the third centerline 96 and the suction valve bore 26 is between about 8% and about 12% of the diameter of the discharge valve bore 32 at the intersection 94.

Similarly, the curvature of the second annular transition zone 90 is preferably formed of a radius R1 between the third centerline 96 and the discharge valve bore 32 of between about 10% and about 24% of the diameter of the discharge valve bore 32 at the intersection 94. According to other embodiments, the curvature of the second annular transition zone 90 has a radius R1 between the third centerline 96 and the discharge valve bore 32 of about 12% and about 20% of the diameter of the discharge valve bore at the intersection 94. According to yet other embodiments, the radius R1 between the third centerline 96 and the discharge valve bore 32 is between about 10% and about 16% of the diameter of the discharge valve bore 32 at the intersection 94. Additionally, the curvature of the second annular transition zone 90 preferably has a radius R2 between the third centerline 96 and the suction valve bore 26 of between about 5% and about 20% of the diameter of the discharge valve bore 32 at the intersection 94. According to other certain embodiments, the curvature of the second annular transition zone 90 preferably has a radius R2 between the third centerline 96 and the suction valve bore 26 of between about 5% and about 15% of the diameter of the discharge valve bore 32 at the intersection 94. According to yet other embodiments, the radius R2 between the third centerline 96 and the suction valve bore 26 is between about 8% and about 12% of the diameter of the discharge valve bore 32 at the intersection 94. In certain embodiments disclosed herein, the first and second annular transitions zones 84 and 90 along with the curvatures having radii R1 and R1, define and/or otherwise create a spherical fluid chamber 22 to thereby reduce the tensile stresses therein.

Referring specifically to FIG. 2, according to some embodiments, the diameter of the suction valve bore 26 expands from a location below the plunger bore 34, such as at location 100, to a location 106, where the suction valve bore 26 meets with the surface of the plunger bore 34 that is generally parallel to the axis 82. In one embodiment, the expansion of the diameter of the suction valve bore 26 is formed by a series of complex segments of curves of varying radii relative to axis 80 on a wall 110 of suction valve bore 26 from a point above the inlet bottle bore 98, such as location 100, through the annular transition zone 84 having radius R2 to the location 106, where the suction valve bore 26 meets with the surface of plunger bore 34. In alternative embodiments, the expansion of the diameter and thus, the curvature of wall 110 of the suction valve bore 26 is formed of a straight line and/or a single radius curve relative to axis 80 from a location above the inlet bottle bore 98, such as at the location 100, to the location 106 to form a generally spherical fluid chamber. In yet other alternative embodiments, the expansion of the diameter of the suction valve bore 26 results in the wall 110 being formed of a combination of two or more of a complex curve of varying radii, a straight line or a single curve radius relative to axis 80 from a point above the inlet bottle bore 98, such as the location 100, to the location 106, where the suction valve bore 26 meets and otherwise blends with the plunger bore 34.

Similarly, the diameter of the discharge valve bore 32 expands from a position above the intersection 94 and below the outlet bottle bore 102, such as at the location 104, to location 112, where the discharge valve bore 32 meets the surface of the plunger bore 34 at a point generally parallel to the axis 82. In one embodiment, the expansion of the diameter of the discharge valve bore 32 results in a wall 116 of the discharge valve bore 32 from above the intersection 94, such as at location 104, through to location 112 being a complex curve of varying radii, including the radius R1 of second annular transition zone 90. In alternative embodiments, this expansion in the diameter of the discharge valve bore 32 results in the wall 116 of the discharge valve bore 32 above intersection 94, such as at location 104, toward location 112 being a straight line or a single radius curve relative to axis 80. In additional alternative embodiments, the expansion in the diameter of the discharge valve bore 32 results in the wall 116 of the discharge valve bore 32 from above intersection 94, such as at location 104, to the location 112, being a combination of two or more of a complex curve of varying radii, a straight line or a single curve radius relative to axis 80. According to embodiments disclosed herein, the diameter of the discharge valve bore 32 at intersection 94 may be less than, equal to, or greater than the diameter of the suction valve bore 26, the plunger bore 34 or the access bore 38.

In addition to defining a radius of curvature for each of the first and second transition zones 84 and 90, in order to substantially reduce the stresses within the fluid chamber 22, the height of fluid chamber 22 is optimized, and in particular, the vertical distances between transitions zones 86 and 90. Referring specifically to FIG. 2, the radius R1 of the curvature of the second transition zone 90 at the intersection 94 includes an apex 150. Similarly, the radius R2 of the curvature of the first transition zone 84 includes an apex 152. In the embodiment illustrated in FIG. 2, the apex 150 at the intersection 94 is vertically spaced apart from the apex 152 a distance such that a line 154 tangent to apex 150 is oriented at an angle of preferably forty-five degrees relative to the centerline 82 and a second line 156 tangent to apex 152 is also oriented at an angle of preferably forty-five degrees relative to the centerline 82. As illustrated, tangent lines 154 and 156 intersect at a single point 158 on the centerline 82 a distance of about two times the radius of the discharge valve bore 32 at the intersection 86 of the discharge valve bore 32 and the plunger bore 34, which establishes a distance between transition zones 86 and 94 to substantially reduce the stresses within fluid chamber 22.

Additional stress reducing configurations includes designing the bores 24, 32, 34 and 38 with different and/or varying diameters. For example, pump housing 20 is configurable such that the diameter of the plunger bore 34 is not equal to the diameter of the suction valve bore 26 below the intersection 86 and above the inlet bottle bore 98, such as at a location 100. Additionally and/or alternatively, the pump housing 20 is configurable such that the diameter of the plunger bore 34 is a different length from the diameter of the discharge valve bore 32 above the intersection 94 below an outlet bottle bore 102, such as at a location 104. In another embodiment, the diameters of the plunger bore 34 and the access bore 38 are greater than the diameter of the suction valve bore 26 at a location below the intersection 86, such as at the location 100. In another embodiment, pump housing 20 is configurable such that the diameters of each of the plunger bore 34 and the access bore 38 are greater than the diameter of the discharge valve bore 32, such as at the location 104. In alternative embodiments, the diameters of the plunger and access bores 34 and 38 are less than either or both of the diameter of the suction valve bore 26 below the intersection 86 and above the inlet valve bottle bore 98, such as at the location 100, and the diameter of the discharge valve bore 32 above the intersection 94 and below the outlet bottle bore 102, such as at the location 104.

The pump assembly 20 is manufactured by forming the suction valve bore 26 and the discharge valve bore 32 along the centerline 80 and forming the plunger bore 34 and the access bore 38 the second centerline 82, which is substantially perpendicular to the centerline 80. The first and second transition zones 84 and 90 are machined by conventional machining techniques. The first annular transition zone 84 is formed to extend around the fluid chamber 22 and between the intersections 86 and 88 and the second annular transition zone 90 is formed to extend around fluid chamber 22 and between the intersections 92 and 94. Both the first and second annular transition zones 84 and 90 are formed with a curvature along their lengths to blend the intersections between the suction bore 26, the discharge bore 32, the plunger bore 34 and the access bore 38 and thus, reducing tensile stresses. Furthermore, the first and second annular transition zones 84 and 90 are formed to intersect along centerline 96 (FIG. 3) generally perpendicular to and extending through the intersection of the first and second centerlines 80 and 82, to thereby reduce tensile stresses on the fluid chamber 22, and in particular, at the intersections 86, 88, 92 and 94.

The pump assembly is further manufactured such that the curvatures of the first annular transition zone 84 includes an apex 152 and the curvature of the second annular transition zone 90 includes a second apex 150, wherein the apex 150 at the intersection 94 is vertically spaced apart from the apex 152 a distance such that a tangent line 154 extending through the apex 150 at a forty-five degree angle relative to the centerline 82 and a tangent line 156 extending through the apex 152 at a forty-five degree angle relative to the centerline 82 intersect at a single point 158 on the centerline 82 a distance of about two time the radius of the discharge valve bore 32 at the intersection 94 of the discharge valve bore 32 and the plunger bore 34.

The embodiments disclosed herein provide advantages such as, for example, stress reductions within the fluid chamber 22. In particular, finite element analysis (FEA) has shown that the von Mises stress along the annular transition zones 84 and 90, and in particular, at the intersections 86, 88, 92 and/or 94, is reduced from between about 25% to 40% over embodiments without having the described annular transition zones 84 and 90.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Directional terms such as “left” and right“, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A reciprocating pump housing, comprising:
a suction valve bore and a discharge valve bore disposed along a first centerline;
a plunger bore and an access bore disposed along a second centerline, the second centerline substantially perpendicular to the first centerline;
a first annular transition zone extending between an intersection of the plunger bore and suction valve bore and an intersection of the access bore and discharge valve bore, the first annular transition zone having a curvature along its length to blend the intersections between the suction valve bore, discharge valve bore, plunger bore, and access bore;
a second annular transition zone extending between an intersection of the suction valve bore and access bore and an intersection of the plunger bore and discharge valve bore, the second annular transition zone having a curvature along its length to blend the intersections between the suction valve bore, discharge valve bore, plunger bore and access bore; and
wherein the first and second annular transition zones intersect along a third centerline generally perpendicular and extending through an intersection of the first and second centerlines to thereby reduce tensile stresses at the first and second annular transition zones.

2. The pump housing of claim 1, wherein the first annular transition zone curvature has a radius between the third centerline and the discharge valve bore of between about 10% and about 24% of the diameter of the discharge valve bore at the intersection of the plunger bore.

3. The pump housing of claim 1, wherein the first annular transition zone curvature has a radius between the third centerline and the discharge valve bore of between about 12% and about 20% of the diameter of the discharge valve bore at the intersection of the plunger bore.

4. The pump housing of claim 1, wherein the first annular transition zone curvature has a radius between the third centerline and the discharge valve bore of between about 10% and about 16% of the diameter of the discharge valve bore at the intersection of the plunger bore.

5. The pump housing of claim 1, wherein the first annular transition zone curvature has a radius between the third centerline and the suction valve bore of between about 5% and about 20% of the diameter of the discharge valve bore at the intersection of the plunger bore and the discharge bore.

6. The pump housing of claim 1, wherein the first annular transition zone curvature has a radius between the third centerline and the suction valve bore of between about 5% and about 15% of the diameter of the discharge valve bore at the intersection of the plunger bore and the discharge bore.

7. The pump housing of claim 1, wherein the first annular transition zone curvature has a radius between the third centerline and the suction valve bore of between about 8% and about 12% of the diameter of the discharge valve bore at the intersection of the plunger bore and the discharge bore.

8. The pump housing of claim 1, wherein the second annular transition zone curvature has a radius between the third centerline and the discharge valve bore of between about 10% and about 24% of the diameter of the discharge valve bore at the intersection of the plunger bore.

9. The pump housing of claim 1, wherein the second annular transition zone curvature has a radius between the third centerline and the discharge valve bore of between about 12% and about 20% of the diameter of the discharge valve bore at the intersection of the plunger bore.

10. The pump housing of claim 1, wherein the second annular transition zone curvature has a radius between the third centerline and the discharge valve bore of between about 10% and about 16% of the diameter of the discharge valve bore at the intersection of the plunger bore.

11. The pump housing of claim 1, wherein the second annular transition zone curvature has a radius between the third centerline and the suction valve bore of between about 5% and about 20% of the diameter of the discharge valve bore at the intersection of the plunger bore and the discharge bore.

12. The pump housing of claim 1, wherein the second annular transition zone curvature has a radius between the third centerline and the suction valve bore of between about 5% and about 15% of the diameter of the discharge valve bore at the intersection of the plunger bore and the discharge bore.

13. The pump housing of claim 1, wherein the second annular transition zone curvature has a radius between the third centerline and the suction valve bore of between about 8% and about 12% of the diameter of the discharge valve bore at the intersection of the plunger bore and the discharge bore.

14. The pump housing of claim 1, wherein the diameter of the suction valve bore at the intersection with the plunger bore is larger than the diameter of the discharge valve bore at the intersection with the plunger bore.

15. The pump housing of claim 1, wherein the diameter of the suction valve bore at the intersection with the plunger bore is different from the diameter of the discharge valve bore at the intersection with the plunger bore.

16. The pump housing of claim 1, wherein the discharge valve bore diameter comprises a diameter different from a diameter of the plunger bore diameter.

17. The pump housing of claim 1, wherein the curvature of the first annular transition zone includes a first apex and the curvature of the second annular transition zone includes a second apex, wherein the first apex at the intersection of the plunger bore and the suction valve bore is vertically spaced apart from the second apex a distance such that a tangent line extending through the first apex at a forty-five degree angle relative to the first centerline and a tangent line extending through the second apex at a forty-five degree angle relative to the first centerline intersect at a single point on the first centerline a distance of about two time the radius of the discharge valve bore at the intersection of the discharge valve bore and the plunger bore.

18. A reciprocating pump housing, comprising:
a suction valve bore having an inlet valve therein to control fluid flow through a suction manifold into a fluid chamber;
a discharge valve bore having a discharge valve to control fluid through a discharge port from the fluid chamber;
a plunger bore for receiving a plunger reciprocatingly movable into and out of the fluid chamber;
an access bore for providing access to the plunger bore;
a first annular transition zone extending between an intersection of the plunger bore and suction valve bore and an intersection of the access bore and discharge bore, the first annular transition zone having a curvature along its length;
a second annular transition zone extending between an intersection of the suction bore and access bore and an intersection of the plunger bore and discharge bore, the first annular transition zone having a curvature along its length; and
whereby the situs of each of the intersections define curved surfaces thereby reducing the tensile stress at all of the intersections.

19. The pump housing of claim 18, wherein the first and second annular transition zones form a generally spherical fluid chamber.

20. The pump housing of claim 18, wherein the first and second annular transition zones intersect along a centerline generally perpendicular to an intersection of a suction valve bore centerline and a plunger bore centerline.

21. The pump housing of claim 20, wherein the first annular transition zone curvature has a radius between the third centerline and the discharge valve bore of between about 10% and about 24% of the diameter of the discharge valve bore at the intersection of the plunger bore.

22. The pump housing of claim 20, wherein the first annular transition zone curvature has a radius between the third centerline and the discharge valve bore of between about 12% and about 20% of the diameter of the discharge valve bore at the intersection of the plunger bore.

23. The pump housing of claim 20, wherein the first annular transition zone curvature has a radius between the third centerline and the discharge valve bore of between about 10% and about 16% of the diameter of the discharge valve bore at the intersection of the plunger bore.

24. The pump housing of claim 20, wherein the first annular transition zone curvature has a radius between the third centerline and the suction valve bore of between about 5% and about 20% of the diameter of the discharge valve bore at the intersection of the plunger bore and the discharge bore.

25. The pump housing of claim 20, wherein the first annular transition zone curvature has a radius between the third centerline and the suction valve bore of between about 5% and about 15% of the diameter of the discharge valve bore at the intersection of the plunger bore and the discharge bore.

26. The pump housing of claim 20, wherein the first annular transition zone curvature has a radius between the third centerline and the suction valve bore of between about 8% and about 12% of the diameter of the discharge valve bore at the intersection of the plunger bore and the discharge bore.

27. The pump housing of claim 20, wherein the second annular transition zone curvature has a radius between the third centerline and the discharge valve bore of between about 10% and about 24% of the diameter of the discharge valve bore at the intersection of the plunger bore.

28. The pump housing of claim 20, wherein the second annular transition zone curvature has a radius between the third centerline and the discharge valve bore of between about 12% and about 20% of the diameter of the discharge valve bore at the intersection of the plunger bore.

29. The pump housing of claim 20, wherein the second annular transition zone curvature has a radius between the third centerline and the discharge valve bore of between about 10% and about 16% of the diameter of the discharge valve bore at the intersection of the plunger bore.

30. The pump housing of claim 20, wherein the second annular transition zone curvature has a radius between the third centerline and the suction valve bore of between about 5% and 20% of the diameter of the discharge valve bore at the intersection of the plunger bore and the discharge bore.

31. The pump housing of claim 20, wherein the second annular transition zone curvature has a radius between the third centerline and the suction valve bore of between about 5% and 15% of the diameter of the discharge valve bore at the intersection of the plunger bore and the discharge bore.

32. The pump housing of claim 20, wherein the second annular transition zone curvature has a radius between the third centerline and the suction valve bore of between about 8% and 12% of the diameter of the discharge valve bore at the intersection of the plunger bore and the discharge bore.

33. A method of manufacturing a reciprocating pump housing, comprising:
forming a suction valve bore and a discharge valve bore along a first centerline;
forming a plunger bore and an access bore along a second centerline, the second centerline substantially perpendicular to the first centerline;
forming a first annular transition zone extending between an intersection of the plunger bore and suction valve bore and an intersection of the access bore and discharge valve bore, the first annular transition zone formed having a curvature along its length to blend the intersections between the suction bore, discharge bore, plunger bore, and access bore;
forming a second annular transition zone extending between an intersection of the suction valve bore and access bore and an intersection of the plunger bore and discharge valve bore, the second annular transition zone formed having a curvature along its length to blend the intersections between the suction bore, discharge bore, plunger bore, and access bore; and
wherein the first and second annular transition zones are formed to intersect along a third centerline generally perpendicular to the intersection of first and second centerlines to thereby reduce tensile stresses on the pump housing.

34. The method of claim 33 further comprising forming the first annular transition zone curvature having a radius between the third centerline and the discharge valve bore of between about 10% and about 24% of the diameter of the discharge valve bore at the intersection of the plunger bore.

35. The method of claim 33 further comprising forming the first annular transition zone curvature having a radius between the third centerline and the discharge valve bore of between about 12% and about 20% of the diameter of the discharge valve bore at the intersection of the plunger bore.

36. The method of claim 33 further comprising forming the first annular transition zone curvature having a radius between the third centerline and the discharge valve bore of between about 10% and about 16% of the diameter of the discharge valve bore at the intersection of the plunger bore.

37. The method of claim 33 further comprising forming the first annular transition zone curvature having a radius between the third centerline and the suction valve bore of between about 5% and about 20% of the diameter of the discharge valve bore at the intersection of the plunger bore and the discharge bore.

38. The method of claim 33 further comprising forming the first annular transition zone curvature having a radius between the third centerline and the suction valve bore of between about 5% and about 15% of the diameter of the discharge valve bore at the intersection of the plunger bore and the discharge bore.

39. The method of claim 33 further comprising forming the first annular transition zone curvature having a radius between the third centerline and the suction valve bore of between about 8% and about 12% of the diameter of the discharge valve bore at the intersection of the plunger bore and the discharge bore.

40. The method of claim 33 further comprising forming the second annular transition zone curvature having a radius between the third centerline and the discharge valve bore of between about 10% and about 24% of the diameter of the discharge valve bore at the intersection of the plunger bore.

41. The method of claim 33 further comprising forming the second annular transition zone curvature having a radius between the third centerline and the discharge valve bore of between about 12% and about 20% of the diameter of the discharge valve bore at the intersection of the plunger bore.

42. The method of claim 33 further comprising forming the second annular transition zone curvature having a radius between the third centerline and the discharge valve bore of between about 10% and about 16% of the diameter of the discharge valve bore at the intersection of the plunger bore.

43. The method of claim 33, further comprising forming the second annular transition zone curvature having a radius between the third centerline and the suction valve bore of between about 5% and about 20% of the diameter of the discharge valve bore at the intersection of the plunger bore and the discharge bore.

44. The method of claim 33, further comprising forming the second annular transition zone curvature having a radius between the third centerline and the suction valve bore of between about 5% and about 15% of the diameter of the discharge valve bore at the intersection of the plunger bore and the discharge bore.

45. The method of claim 33, further comprising forming the second annular transition zone curvature having a radius between the third centerline and the suction valve bore of between about 8% and about 12% of the diameter of the discharge valve bore at the intersection of the plunger bore and the discharge bore.

46. A reciprocating pump housing, comprising:
a suction valve bore and a discharge valve bore disposed along a first centerline;
a plunger bore and an access bore disposed along a second centerline, the second centerline substantially perpendicular to the first centerline;
a first annular transition zone extending between an intersection of the plunger bore and suction valve bore and an intersection of the access bore and discharge valve bore, the first annular transition zone having a curvature along its length to blend the intersections between the suction valve bore, discharge valve bore, plunger bore, and access bore;
a second annular transition zone extending between an intersection of the suction valve bore and access bore and an intersection of the plunger bore and discharge valve bore, the second annular transition zone having a curvature along its length to blend the intersections between the suction valve bore, discharge valve bore, plunger bore and access bore; and
wherein the curvature of the first annular transition zone includes a first apex and the curvature of the second annular transition zone includes a second apex, wherein the first apex at the intersection of the plunger bore and the suction valve bore is vertically spaced apart from the second apex a distance such that a tangent line extending through the first apex at a forty-five degree angle relative to the first centerline and a tangent line extending through the second apex at a forty-five degree angle relative to the first centerline intersect at a single point on the first centerline a distance of about two time the radius of the discharge valve bore at the intersection of the discharge valve bore and the plunger bore.

47. The pump housing of claim 46, wherein the first and second annular transition zones intersect along a third centerline generally perpendicular to the intersection of first and second centerlines to thereby reduce tensile stresses at the first and second annular transition zones.

48. The pump housing of claim 47, wherein the first annular transition zone curvature has a radius between the third centerline and the discharge valve bore of between about 10% and about 24% of the diameter of the discharge valve bore at the intersection of the plunger bore.

49. The pump housing of claim 47, wherein the first annular transition zone curvature has a radius between the third centerline and the suction valve bore of between about 5% and about 20% of the diameter of the discharge valve bore at the intersection of the plunger bore and the discharge bore.

50. The pump housing of claim 47, wherein the second annular transition zone curvature has a radius between the third centerline and the discharge valve bore of between about 10% and about 24% of the diameter of the discharge valve bore at the intersection of the plunger bore.

51. The pump housing of claim 47, wherein the second annular transition zone curvature has a radius between the third centerline and the suction valve bore of between about 5% and about 20% of the diameter of the discharge valve bore at the intersection of the plunger bore and the discharge bore.

52. A method of manufacturing a reciprocating pump housing, comprising:
forming a suction valve bore and a discharge valve bore along a first centerline;
forming a plunger bore and an access bore along a second centerline, the second centerline substantially perpendicular to the first centerline;
forming a first annular transition zone extending between an intersection of the plunger bore and suction valve bore and an intersection of the access bore and discharge valve bore, the first annular transition zone formed having a curvature with an apex;
forming a second annular transition zone extending between an intersection of the suction valve bore and access bore and an intersection of the plunger bore and discharge valve bore, the first annular transition zone formed having a curvature with an apex; and
positioning the apex of the first annular transition zone apart from the apex of the second annular transition zone a distance such that a tangent line extending through the apex of the first annular transition zone at a forty-five degree angle relative to the first centerline and a tangent line extending through the apex of the second annular transition zone at a forty-five degree angle relative to the first centerline intersect at a single point on the first centerline at a distance of about twice the radius of the discharge valve bore at the intersection of the discharge valve bore and the plunger bore.
